(19) United States
(12) Patent Application Publication
(10) Pub. No.: US 2025/0068418 A1
(43) Pub. Date: Feb. 27, 2025

(54) System and Method for Developing Web Applications

(71) Applicant: Bank of America Corporation, Charlotte, NC (US)

(72) Inventors: Divya Sharma, Delhi (IN); Surendra Korrapati, Hyderabad (IN); Hari Kumar Vemula, Hyderabad (IN)

(21) Appl. No.: 18/454,877

(22) Filed: Aug. 24, 2023

(51) Int. Cl. G06F 8/75; G06F 11/36

(52) U.S. Cl. CPC G06F 8/75; G06F 11/3688

(57) ABSTRACT

A method includes accessing a first instance of a first web application screen and a second instance of the first web application screen, generating key-value pairs for each web element identified in the first instance and the second instance, and generating a first element map based on the key-value pairs. The method further includes accessing a third instance of the first web application screen, and generating an updated element map based on the first element map and a second element map generated based on the third instance. The method includes executing a machine-learning model trained to generate a prediction of key-value pairs for instances of a second web application screen based on the updated element map and a wireframe of the second web application screen, and generating a final element map based on the prediction of key-value pairs and the wireframe of the second web application screen.

### TECHNICAL FIELD

The present disclosure relates generally to web applications, and, more specifically, to a system and method for developing web applications.

### BACKGROUND

Web application design and development generally includes designing and developing the frontend of the web application and the backend of the web application. Specifically, the frontend may include all of the parts of the web application that are intended to interface directly with a web browser of a user. For example, the frontend may be developed utilizing languages, such as HTML, CSS, and JavaScript for web applications and Objective-C, Swift, Java, or Kotlin for iOS and Android applications. In some examples, the frontend development and the overall web application development, for example, from commencement of the design process to completion, may be time sensitive in terms of both technical efficiency and usefulness. Additionally, while many web application design processes include automation testing, which may include a software testing process that automates the process of validating the functionality of the frontend and web application, automation testing may be time-consuming and further impede the time-to-market (TTM) of the frontend and web application.

### SUMMARY

The system and methods implemented by the system as disclosed in the present disclosure provide technical solutions to the technical problems discussed above by providing systems and methods for predicting and generating key-value pairs for synchronizing development and testing of frontend web applications. The disclosed system and methods provide several practical applications and technical advantages.

The present embodiments are directed systems and methods for predicting and generating key-value pairs for synchronizing development and testing of frontend web applications. In particular embodiments, one or more processors of a system may access a first instance of a first web application screen and a second instance of the first web application screen stored to a memory of the system. The one or more processors may then generate one or more key-value pairs for each web element identified in the first instance of the first web application screen and the second instance of the first web application screen. For example, in particular embodiments, prior to generating the one or more key-value pairs, the one or more processors may access the first instance of the first web application screen during runtime and access the second instance of the first web application screen during development time.

In particular embodiments, the one or more processors may then generate a first element map based on the one or more key-value pairs and access a third instance of the first web application screen stored to the memory. In particular embodiments, the one or more processors may then generate an updated element map based on the first element map and a second element map generated based on a third instance of the first web application screen. In one embodiment, the updated element map may include one or more key-value pairs updated for a context of the third instance of the first web application screen. In particular embodiments, prior to generating the updated element map, the one or more processors may access the third instance of the first web application screen while the third instance of the first web application screen is executing on a mobile device.

In particular embodiments, the one or more processors may generate the updated element map further by receiving an input corresponding to the first element map, generating the second element map based on the third instance of the first web application screen, comparing the first element map and the second element map, and generating the updated element map based on the comparison of the first element map and the second element map. In particular embodiments, the one or more processors may then execute a machine-learning model trained to generate a prediction of one or more key-value pairs for one or more instances of a second web application screen based on the updated element map and a wireframe of the second web application screen. For example, in particular embodiments, the machine-learning model may be trained to generate the prediction of one or more key-value pairs for the one or more instances of the second web application screen utilizing the updated element map as a seed input. In one embodiment, the machine-learning model may include one or more sequence-to-sequence (Seq2Seq) models, one or more encoder-decoder sequence models, or one or more transformer models.

In particular embodiments, the one or more processors may then generate a final element map based on the prediction of one or more key-value pairs and the wireframe of the second web application screen. For example, in particular embodiments, the one or more processors may generate the final element map by receiving the prediction of one or more key-value pairs generated by the machine-learning model, receiving the wireframe of the second web application screen, and generating the final element map based on the prediction of one or more key-value pairs and the wireframe of the second web application screen. In particular embodiments, the first web application screen may include an existing web application screen and the second web application screen may include a new web application screen. In particular embodiments, the one or more processors may then receive the final element map and execute one or more tests of the second web application screen utilizing the final element map.

Thus, in accordance with the presently disclosed embodiments, the one or more processors may identify, validate, and generate the key-value pairs of existing web application screens and in-development web application screens stored to memory, and then further predict and generate the key-value pairs for new web application screens (e.g., web application screens yet to be written, developed, or tested) that may be utilized for both the development process and the testing process of the web application design process associated with the development of the new web application screen. In this way, the present embodiments may improve the processing speed of the one or more processors and reduce memory usage of the memory by predicting and generating the key-value pairs for new web application screens in synchronization for both development and testing, and thereby reducing the number of calls and storage to the memory and the potential redundant processing of siloed data between the development resources and the testing resources.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system for predicting and generating key-value pairs for synchronizing development and testing of frontend web applications, in accordance with certain aspects of the present disclosure;

FIG. 2 is a block diagram of an embodiment of a locator component processor and web application environment, in accordance with certain aspects of the present disclosure;

FIG. 3 is a block diagram of an embodiment of a validator component processor and web application environment, in accordance with certain aspects of the present disclosure;

FIG. 4 is a block diagram of an embodiment of a generator component processor and web application environment, in accordance with certain aspects of the present disclosure; and

FIG. 5 illustrates a flowchart of an example method for predicting and generating key-value pairs for synchronizing development and testing of a frontend web applications, in accordance with one or more embodiments of the present disclosure.

### DETAILED DESCRIPTION

### Example System

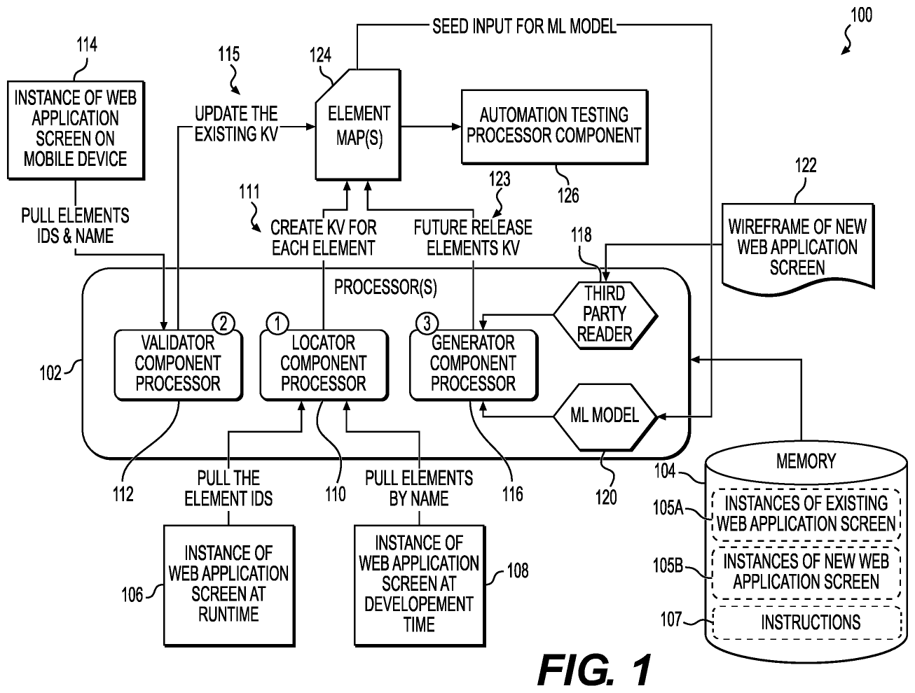

FIG. 1 is a schematic diagram of a system 100 predicting and generating key-value pairs for synchronizing development and testing of frontend web applications, in accordance with certain aspects of the present disclosure. As depicted, in particular embodiments, the system 100 may include one or more processors 102 and a memory 104, which may be utilized in conjunction to predict and generate key-value pairs for synchronizing development and testing of frontend web applications in accordance with the presently disclosed embodiments. In particular embodiments, the one or more processors 102 may be operably coupled to the memory 104.

For example, in some embodiments, the one or more processors 102 may include any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). In some embodiments, the one or more processors 102 may be a programmable logic device, a microcontroller, a microprocessor, or any suitable combination of the preceding.

In particular embodiments, the one or more processors 102 may be further communicatively coupled to and in signal communication with the memory 104. The one or more processors may be configured to process data and may be implemented in hardware or software. For example, the one or more processors 102 may be 8-bit, 16-bit, 32-bit, 64-bit or of any other suitable architecture. The one or more processors 102 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

In particular embodiments, the one or more processors 102 may be further configured to implement various instructions 107. For example, the one or more processors 102 may be configured to execute instructions (e.g., instances of an existing web application screen 105A, instances of a new web application screen 105B) stored by the memory 104. In such instances, the one or more processors 102 may be a special-purpose computer designed to implement and execute the functions disclosed herein.

In particular embodiments, the memory 104 may include one or more disks, tape drives, or solid-state drives, and may be used as an over-flow data storage device, to store programs when such programs are selected for execution, and to store instructions and data that are read during program execution. The memory 104 may be volatile or non-volatile and may include a read-only memory (ROM), random-access memory (RAM), ternary content-addressable memory (TCAM), dynamic random-access memory (DRAM), static random-access memory (SRAM), and so forth. As further depicted by the system 100 of FIG. 1, in particular embodiments, the memory 104 may be operable to store instances of an existing web application screen 105A and instances of a new web application screen 105B. For example, in particular embodiments, the instances of an existing web application screen 105A may include, for example, an instance of an existing runtime web application screen 106 and an instance of an in-development development time web application screen 108.

In particular embodiments, as further depicted by the system 100 of FIG. 1, the one or more processors 102 may include a locator component processor 110, a validator component processor 112, and a generator component processor 116. Although these processors 110, 112, and 116 are illustrated as separate components, they may be implemented in any suitable number and combination of processors to suitable particular needs of system 100. In particular embodiments, the locator component processor 110 may access the runtime web application screen 106 and access the development time web application screen 108. The locator component processor 110 may then generate one or more key-value pairs 111 for each web element identified in the runtime web application screen 106 and the development time web application screen 108. For example, in particular embodiments, the one or more key-value pairs 111 may include any dataset consisting of two related data elements, such as a key or index (e.g., “username,” “password”) that defines the dataset and a value or element is the variable that belongs to the dataset (e.g., “newUser1”, “password!@#$%”).

In particular embodiments, having generated the one or more key-value pairs 111, the locator component processor 110 may then generate an element map 124 based on the one or more key-value pairs 111. Specifically, the locator component processor 112 may generate an element map 124 utilizing the one or more key-value pairs 111 generated for each web element identified in the runtime web application screen 106 and the development time web application screen 108. In particular embodiments, as further depicted by the system 100 of FIG. 1, the validator component processor 112 may access an instance of the web application screen 114 while, for example, the instance of the web application screen 114 is executing on a mobile device.

For example, in one embodiment, the instance of the web application screen 114 may be a mobile web application, and thus the validator component processor 112 may be utilized to validate the instance of the web application screen 114 for the computing environment context for which the instance of the web application screen 114 is to be native. In particular embodiments, the validator component processor 112 may then generate one or more key-value pairs 115 updated for the instance of the web application screen 114 executing on the mobile device.

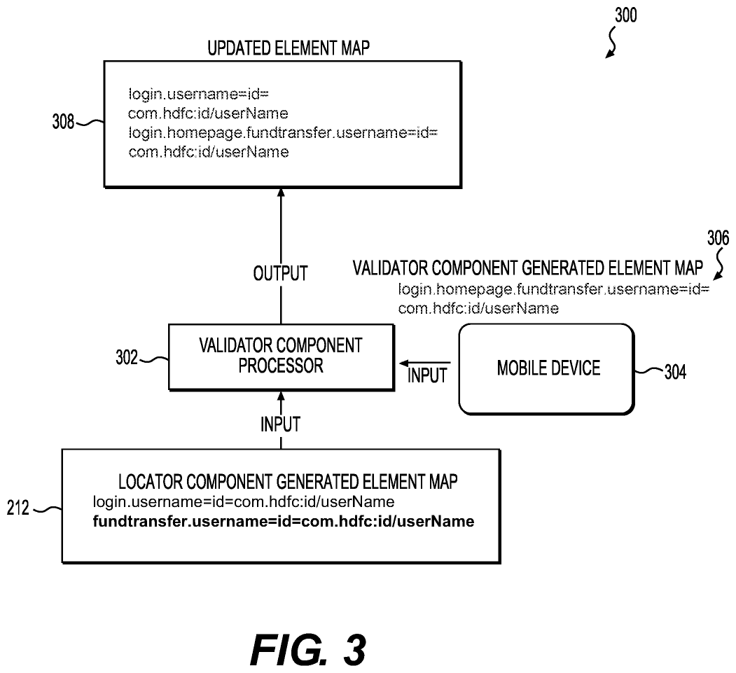

In particular embodiments, the validator component processor 112 may then update the element map 124 with the one or more key-value pairs 115 updated for the instance of the web application screen 114 executing on the mobile device. For example, as will be described in greater detail below with respect to FIG. 3, the validator component processor 112 may compare an element map generated by the locator component processor 110 utilizing the one or more key-value pairs 111 and an element map generated by the validator component processor 112 utilizing the one or more key-value pairs 115, and then update the element map 124 based on the comparison of element maps.

In particular embodiments, as further depicted by the system 100 of FIG. 1, the updated element map 124 may then be provided to a machine-learning model 120 as a seed input to the machine-learning model 120. For example, in accordance with the presently disclosed embodiments, the machine-learning model 120 may include one or more sequence-to-sequence (Seq2Seq) models, one or more encoder-decoder sequence models, one or more transformer models, or one or more other language-based models that may be trained to generate a prediction of one or more key-value pairs 123 for one or more instances of a new web application screen based on the updated element map 124 and the one or more wireframes of a new web application screen 122. For example, in particular embodiments, the one or more wireframes of a new web application screen 122 may include a template, a layout, a computer-generated sketch, or other example plan of a new web application screen (e.g., a web application screen yet to be written, developed, or tested) within the preliminary stages of a design and development process.

In particular embodiments, the generator component processor 116 may monitor for inputs from a third-party reader 118 (e.g., third-party computing device) corresponding to one or more wireframes of a new web application screen 122. In particular embodiments, in response to the generator component processor 116 receiving the one or more wireframes of a new web application screen 122 and the machine-learning model 120 receiving the input of the updated element map 124, the generator component processor 116, in conjunction with the machine-learning model 120, may then generate a prediction of one or more key-value pairs 123 for one or more instances of a new web application screen based on the updated element map 124 and the one or more wireframes of a new web application screen 122.

In particular embodiments, as further depicted by the system 100 of FIG. 1, the generator component processor 116 may then provide the prediction of one or more key-value pairs 123 to the element map 124 to generate a finalized element map 124. In particular embodiments, the finalized element map 124 including the predicted one or more key-value pairs 123 may be then utilized to synchronize a development process and a testing process of the web application design process associated with the development of the new web application screen. For example, in particular embodiments, the generator component processor 116 may then input the finalized element map 124 to an automation testing processor component 126, which may be utilized to execute one or more tests of the new web application screen utilizing the finalized element map 124 including the predicted one or more key-value pairs 123.

In this way, as will be discussed in greater detail below with respect to FIGS. 3-5, the one or more processors 102 (e.g., locator component processor 110, validator component processor 112, and generator component processor 116) may identify, validate, and generate the key-value pairs of existing web application screens and in-development web application screens, and then further predict and generate the key-value pairs for new web application screens (e.g., web application screens yet to be written, developed, or tested) that may be utilized for both the development process and the testing process of the web application design process associated with the development of the new web application screen.

### Predicting Key-Value Pairs for Synchronizing Development and Testing of Frontends

Embodiments of the present disclosure discuss techniques for predicting and generating key-value pairs for synchronizing development and testing of frontend web applications.

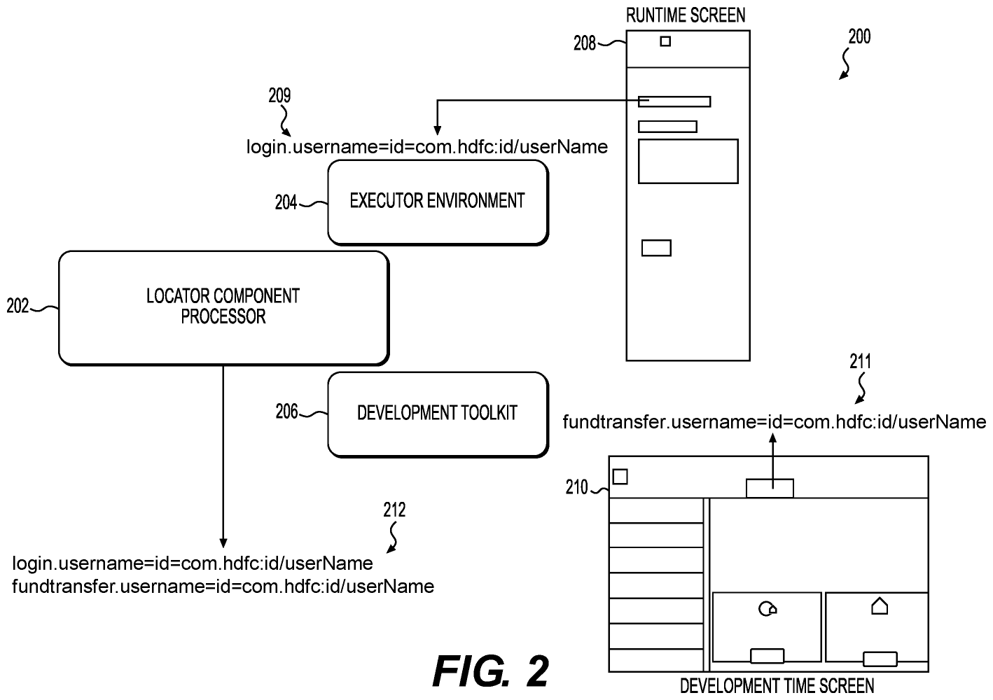

FIG. 2 is a block diagram of an embodiment of a locator component processor and web application environment 200, in accordance with certain aspects of the present disclosure. As depicted, in particular embodiments, the locator component processor web application environment 200 may include a locator component processor 202, executor environment 204, and a development toolkit 206. In particular embodiments, the executor environment 204 may include any physical or virtual computing resources (e.g., hardware processors, software systems, or combinations thereof) that may be suitable for executing a runtime web application screen 208. For example, during a web application design and development process, the executor environment 204 may execute at runtime an instance of an existing web application, which may correspond to the runtime web application screen 208.

In particular embodiments, the development toolkit 206 may include any set of software routines and utilities (e.g., libraries, protocols, and so forth) that may be suitable for developing a development time web application screen 210. For example, during the web application design and development process, the development time web application screen 210 may include an instance of a web application currently in development. In particular embodiments, the locator component processor 202 may then generate one or more key-value pairs 209 for each web element identified in the runtime web application screen 208 and one or more key-value pairs 211 for each web element identified in the development time web application screen 210.

For example, in particular embodiments, the locator component processor 202 may access the runtime web application screen 208 and the development time web application screen 210 to generate the one or more key-value pairs 209 and to generate the one or more key-value pairs 211, respectively. The locator component processor 202 may then generate a first element map 212 based on the one or more key-value pairs 209 and the one or more key-value pairs 211.

FIG. 3 is a block diagram of an embodiment of a validator component processor and web application environment 300, in accordance with certain aspects of the present disclosure. As depicted, in particular embodiments, the validator component processor web application environment 300 may include a validator component processor 302 and mobile device 304. In particular embodiments, the mobile device 304 may include any mobile electronic device (e.g., handheld user electronic device, wearable user electronic device) that may be suitable for executing one or more mobile web applications. In particular embodiments, the validator component processor 302 may access an instance of the web application screen (e.g., instance of the web application screen 114) while, for example, the instance of the web application screen 114 is executing on the mobile device 304. In particular embodiments, the validator component processor 302 may then generate the second element map 306 based on the instance of the web application screen 114, for example.

In particular embodiments, as further depicted by FIG. 3, the validator component processor 302 may receive an input of the first element map 212 from the locator component processor 202, and then compare the first element map 212 and the second element map 306 to determine whether the first element map 212 matches to the second element map 306. In particular embodiments, based on the comparison of the first element map 212 and the second element map 306, the validator component processor 302 may then generate an updated element map 308 based on the first element map 212 and the second element map 306. For example, in particular embodiments, the updated element map 308 may include one or more key-value pairs 115 updated for a context of the instance of the web application screen 114 executing on the mobile device 304.

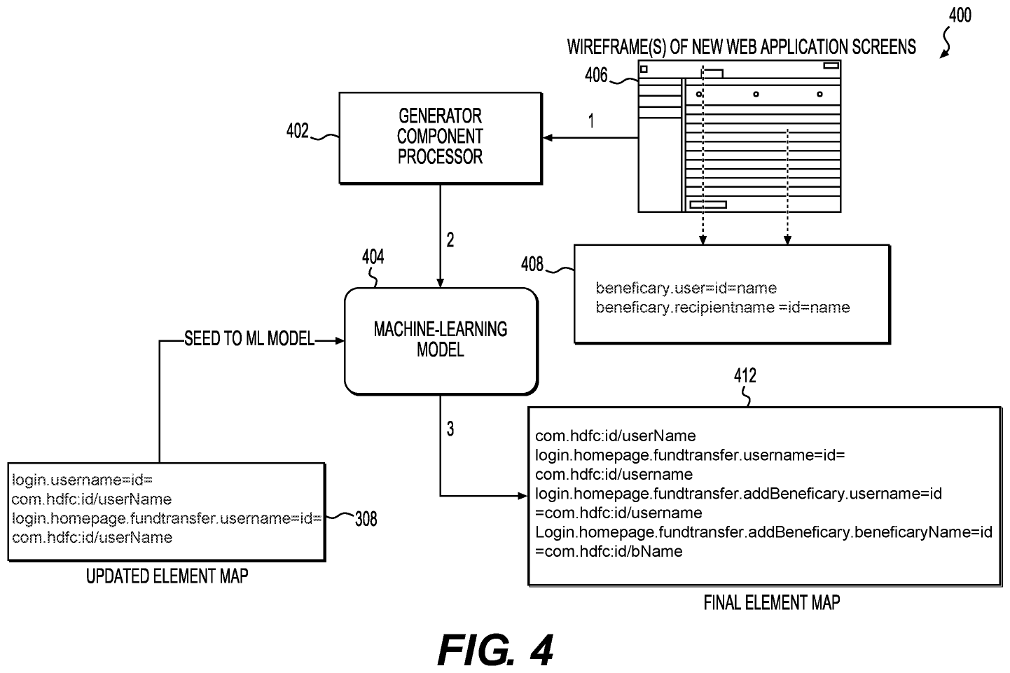

FIG. 4 is a block diagram of an embodiment of a generator component processor and web application environment 400, in accordance with certain aspects of the present disclosure. As depicted, in particular embodiments, the generator component processor and web application environment 400 may include a generator component processor 402 and machine-learning model 404. In particular embodiments, the generator component processor 402 may receive inputs corresponding to one or more wireframes of a new web application screen 406. For example, as generally discussed above with respect to FIG. 1, the generator component processor 402 may monitor for inputs from a third-party reader 118 (e.g., third-party computing device) corresponding to one or more wireframes of a new web application screen 406 currently in the preliminary stages of the web application design and development process.

In particular embodiments, in response to the generator component processor 402 receiving the one or more wireframes of a new web application screen 406, the generator component processor 402 may then input data associated with the one or more wireframes of a new web application screen 406 to the machine-learning model 404. In particular embodiments, the machine-learning model 404 (e.g., one or more Seq2Seq models, one or more encoder-decoder sequence models, one or more transformer models, or one or more other language-based models) may be trained to generate a prediction of one or more key-value pairs 123 for one or more instances of a second web application screen based on the updated element map 308 and the one or more wireframes of a new web application screen 406.

In particular embodiments, as further depicted by FIG. 4, the updated element map 308, as generated by the validator component processor 302 and discussed above with respect to FIG. 3, may be inputted into the machine-learning model 404 as a seed input to the machine-learning model 404. In particular embodiments, based on the updated element map 308 and the one or more wireframes of a new web application screen 406, the machine-learning model 404 may then generate a prediction of one or more key-value pairs 123 for one or more instances of a second web application screen. For example, in particular embodiments, the machine-learning model 404 may generate a prediction of a final element map 412 based on the prediction of one or more key-value pairs 123 and the one or more wireframes of a new web application screen 406.

In particular embodiments, the final element map 412 may be utilized to synchronize a development process and a testing process of the web application design process associated with the development of the new web application screen. Specifically, in one embodiment, as generally discussed above with respect to FIG. 1, the generator component processor 402 may then input the final element map 412 to the automation testing processor component 126, which may be utilized to execute one or more tests of the new web application screen utilizing the final element map 412. In this way, the present embodiments may identify, validate, and generate the key-value pairs of existing web application screens and in-development web application screens, and then further predict and generate the key-value pairs for new web application screens (e.g., web application screens yet to be written, developed, or tested) that may be utilized for both the development process and the testing process of the web application design process associated with the development of the new web application screen.

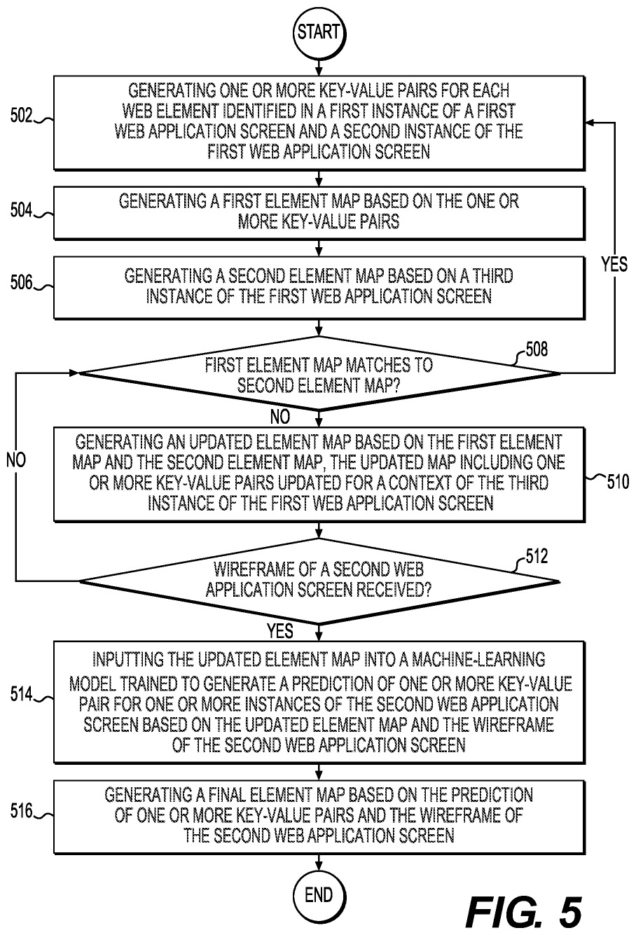

FIG. 5 illustrates a flowchart of an example method 500 for predicting and generating key-value pairs for synchronizing development and testing of frontend web applications, in accordance with one or more embodiments of the present disclosure. The method 500 may be performed utilizing the one or more processors 102 (e.g., locator component processor 110, validator component processor 112, and generator component processor 116) as described above with respect to FIG. 1 and/or locator component processor 202, validator component processor 302, and generator component processor 402 as described above with respect to FIGS. 2, 3, and 4, respectively.

The method 500 may begin at block 502 with the locator component processor 202 generating one or more key-value pairs 111 for each web element identified in a first instance of a first web application screen (e.g., runtime web application screen 208) and a second instance of the first web application screen (e.g., development time web application screen 210). For example, in particular embodiments, the locator component processor 202 may access runtime web application screen 208 and access development time web application screen 210. The locator component processor 202 may then generate one or more key-value pairs 111 for each web element identified in the runtime web application screen 208 and the development time web application screen 210.

In particular embodiments, the method 500 may then continue at block 504 with the locator component processor 202 generating a first element map 212 based on the one or more key-value pairs 111. For example, in particular embodiments, the locator component processor 202 may generate a first element map 212 utilizing the one or more key-value pairs 111 generated for each web element identified in the runtime web application screen 208 and the development time web application screen 210.

In particular embodiments, the method 500 may then continue at block 506 with the validator component processor 302 generating a second element map 306 based on a third instance of the first web application screen (e.g., instance of the web application screen 114). For example, in particular embodiments, the validator component processor 302 may access an instance of the web application screen 114 while, for example, the instance of the web application screen 114 is executing on a mobile device 304. In particular embodiments, the validator component processor 302 may then generate the second element map 306 based on the instance of the web application screen 114.

In particular embodiments, the method 500 may then continue at decision 508 with the validator component processor 302 determining whether the first element map 212 matches to the second element map 306. For example, in particular embodiments, the validator component processor 302 may receive an input of the first element map 212 from the locator component processor 202, and then compare the first element map 212 and the second element map 306 to determine whether the first element map 212 matches to the second element map 306.

In particular embodiments, in response to the validator component processor 302 determining that the first element map 212 matches to the second element map 306 (e.g., at decision 508), the method 500 may return to block 502. In particular embodiments, in response to the validator component processor 302 determining that the first element map 212 does not match to the second element map 306 (e.g., at decision 508), the method 500 continue at block 510 with the validator component processor 302 generating an updated element map 308 based on the first element map 212 and the second element map 306.

For example, in particular embodiments, the updated element map 308 may include, for example, one or more key-value pairs 115 updated for the instance of the web application screen 114 executing on the mobile device 304. In particular embodiments, the method 500 may then continue at decision 512 with the generator component processor 402 determining whether one or more wireframes of a new web application screen 406 has been generated. For example, in particular embodiments, the generator component processor 402 may monitor for inputs from a third-party reader 118 (e.g., third-party computing device) corresponding to one or more wireframes of a new web application screen 406. In particular embodiments, in response to the generator component processor 402 determining that the one or more wireframes of a new web application screen 406 has not been generated (e.g., at decision 512), the method 500 may return to decision 508.

In particular embodiments, in response to the generator component processor 402 determining that the one or more wireframes of a new web application screen 406 has been generated (e.g., at decision 512), the method 500 continue at block 514 with the generator component processor 402 inputting the updated element map 308 into the machine-learning model 404 trained to generate a prediction of one or more key-value pairs 123 for one or more instances of a second web application screen based on the updated element map 308 and the one or more wireframes of a new web application screen 406.

In particular embodiments, the method 500 then conclude at block 516 with the generator component processor 402 generating a final element map 412 based on the prediction of one or more key-value pairs 123 and the one or more wireframes of a new web application screen 406. For example, in particular embodiments, the final element map 412 may be utilized to synchronize a development process and a testing process of a web application design process associated with a development of the new web application screen.

Thus, in accordance with the presently disclosed embodiments, a one or more processors 102 of the system 100 may identify, validate, and generate the key-value pairs of existing web application screens and in-development web application screens, and then further predict and generate the key-value pairs for new web application screens (e.g., web application screens yet to be written, developed, or tested) that may be utilized for both the development process and the testing process of the web application design process associated with the development of the new web application screen.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store a first instance of a first web application screen, a second instance of the first web application screen, a third instance of the first web application screen, and one or more instances of a second web application screen; and
one or more processors operably coupled to the memory and configured to:
access the first instance of the first web application screen and the second instance of the first web application screen;
generate one or more key-value pairs for each web element identified in the first instance of the first web application screen and the second instance of the first web application screen;
generate a first element map based on the one or more key-value pairs;
access the third instance of the first web application screen;
generate an updated element map based on the first element map and a second element map, wherein the second element map is generated based on the third instance of the first web application screen, wherein the updated element map comprises one or more key-value pairs updated for a context of the third instance of the first web application screen;
execute a machine-learning model trained to generate a prediction of one or more key-value pairs for the one or more instances of the second web application screen based at least in part upon the updated element map and a wireframe of the second web application screen; and
generate a final element map based on the prediction of one or more key-value pairs.

2. The system of claim 1, wherein the one or more processors are further configured to:
access the first instance of the first web application screen during runtime; and
access the second instance of the first web application screen during development time.

3. The system of claim 1, wherein the one or more processors are further configured to access the third instance of the first web application screen while the third instance of the first web application screen is executing on a mobile device.

4. The system of claim 1, wherein the one or more processors are further configured to:
receive an input corresponding to the first element map;
generate the second element map based on the third instance of the first web application screen;
compare the first element map and the second element map; and
generate the updated element map based on the comparison of the first element map and the second element map.

5. The system of claim 1, wherein the machine-learning model is trained to generate the prediction of one or more key-value pairs for the one or more instances of the second web application screen utilizing the updated element map as a seed input.

6. The system of claim 5, wherein the machine-learning model comprises one or more sequence-to-sequence (Seq2Seq) models, one or more encoder-decoder sequence models, or one or more transformer models.

7. The system of claim 1, wherein the one or more processors are further configured to:
receive the prediction of one or more key-value pairs generated by the machine-learning model;
receive the wireframe of the second web application screen; and
generate the final element map based on the prediction of one or more key-value pairs and the wireframe of the second web application screen.

8. The system of claim 1, wherein the first web application screen comprises an existing web application screen, and wherein the second web application screen comprises a new web application screen.

9. The system of claim 1, wherein the one or more processors are further configured to:
receive the final element map; and
execute one or more tests of the second web application screen utilizing the final element map.

10. The system of claim 9, wherein the final element map is utilized to synchronize a development process and a testing process of a web application design process associated with a development of the second web application screen.

11. A method, comprising:
accessing a first instance of a first web application screen and a second instance of the first web application screen;
generating one or more key-value pairs for each web element identified in the first instance of the first web application screen and the second instance of the first web application screen;
generating a first element map based on the one or more key-value pairs;
accessing a third instance of the first web application screen;
generating an updated element map based on the first element map and a second element map generated based on a third instance of the first web application screen, wherein the updated element map comprises one or more key-value pairs updated for a context of the third instance of the first web application screen;
executing a machine-learning model trained to generate a prediction of one or more key-value pairs for one or more instances of a second web application screen based on the updated element map and a wireframe of the second web application screen; and
generating a final element map based on the prediction of one or more key-value pairs and the wireframe of the second web application screen.

12. The method of claim 11, further comprising:
accessing the first instance of the first web application screen during runtime; and
accessing the second instance of the first web application screen during development time.

13. The method of claim 11, further comprising:
prior to generating the updated element map, accessing the third instance of the first web application screen while the third instance of the first web application screen is executing on a mobile device.

14. The method of claim 11, wherein generating the updated element map further comprises:
receiving an input corresponding to the first element map;
generating the second element map based on the third instance of the first web application screen;
comparing the first element map and the second element map; and
generating the updated element map based on the comparison of the first element map and the second element map.

15. The method of claim 11, wherein the machine-learning model is trained to generate the prediction of one or more key-value pairs for the one or more instances of the second web application screen utilizing the updated element map as a seed input.

16. The method of claim 15, wherein the machine-learning model comprises one or more sequence-to-sequence (Seq2Seq) models, one or more encoder-decoder sequence models, or one or more transformer models.

17. The method of claim 11, wherein generating the final element map further comprises:
receiving the prediction of one or more key-value pairs generated by the machine-learning model;
receiving the wireframe of the second web application screen; and
generating the final element map based on the prediction of one or more key-value pairs and the wireframe of the second web application screen.

18. The method of claim 11, wherein the first web application screen comprises an existing web application screen, and wherein the second web application screen comprises a new web application screen.

19. The method of claim 11, further including:
receiving the final element map; and
executing one or more tests of the second web application screen utilizing the final element map.

20. A non-transitory computer-readable medium comprising instructions that, when executed by one or more processors, cause the one or more processors to:
access a first instance of a first web application screen and a second instance of the first web application screen;
generate one or more key-value pairs for each web element identified in the first instance of the first web application screen and the second instance of the first web application screen;
generate a first element map based on the one or more key-value pairs;
access a third instance of the first web application screen;
generate an updated element map based on the first element map and a second element map generated based on a third instance of the first web application screen, wherein the updated element map comprises one or more key-value pairs updated for a context of the third instance of the first web application screen;
execute a machine-learning model trained to generate a prediction of one or more key-value pairs for one or more instances of a second web application screen based on the updated element map and a wireframe of the second web application screen; and
generate a final element map based on the prediction of one or more key-value pairs and the wireframe of the second web application screen.
